(19) United States
(12) Patent Application Publication
(10) Pub. No.: US 2008/0052771 A1
(43) Pub. Date: Feb. 28, 2008

(54) Method and System for Certifying a User Identity

(76) Inventors: Frederic Delmond, Paris (FR); Jean-Michel Crom, Rennes (FR)

Correspondence Address: Thomas Langer;Cohen Pontani Lieberman Pavane LLP, 551 Fifth Avenue, Suite 1210, New York, NY, 10176, US

(21) Appl. No.: 11/630,938

(22) PCT Filed: Jun. 21, 2005
(86) PCT No.: PCT/FR05/01562

§ 371 Date: May 18, 2007

(30) Foreign Application Priority Data
Jun. 29, 2004 (FR) 04 51363

(51) Int. Cl. H04L 9/32

(52) U.S. Cl. 726/9

(57) ABSTRACT

System for certifying the identity of a user of a terminal (10) after the execution of a procedure for controlling access to a packet network (20). The system comprises an access server (11) adapted to receive a correlation element from said terminal (10) at the time of a request for connection to said packet network (20), an identity server (14) adapted to send a cookie to the terminal (10) after receiving a request from the terminal (10), and a proxy server (12) adapted to send said correlation element and a user identifier from said access server (11) to a database (13) connected to the identity server (14), the terminal (10) being adapted to send said cookie at the time of a request for connection to a service provider (30) in order to retrieve said user identifier sent at the time of execution of said procedure for controlling access to the packet server (20). Application to certifying the identity of a terminal user at the time of a request to authenticate said user after the execution of a procedure for controlling access to a packet network.

The present invention relates to a method and a system for certifying the identity of a user.

The invention applies more particularly to certifying the identity of a user of a terminal at the time of a request for authentication of said user following a packet network access control procedure.

The packet network may be a public network for IP (Internet Protocol) packet transmission, in particular the Internet, a private network for IP packet transmission, such as a company's Intranet, or any other packet network access to which by users is controlled by an AAA (authentication, authorization, accounting) type protocol. Generally speaking, packet network access control is effected by an identification and authentication procedure using an identifier and a password. After access validation, the user receives authorization to send information over the network to which the user is connected.

At present, following an access control procedure carried out for the purpose of setting up a connection to a packet network, users must identify and authenticate themselves again each time that they wish to access a personal or confidential service available via the packet network. Because the personalization and confidentiality of the services offered are becoming more and more important, it is often necessary for users to be identified and authenticated as part of the procedure that controls access to said services. Given the increasing number of services requiring access control, users must repeatedly identify themselves by means of identifiers and passwords that are usually different, even after being identified already at the outset in order to be able to access the packet network.

When controlling access to the Internet, users generally identify themselves to their Internet Service Providers (ISP) by means of a connection kit. A public or private IP address is assigned to the user's terminal on connecting to the network and is used to route traffic to the terminal.

When controlling access to an Intranet, a public IP address is first assigned to the user's terminal. Once the connection to the Intranet is active, the terminal uses a private IP address corresponding to the Intranet addressing domain.

Whatever the way in which the network is accessed, the user's terminal uses its own permanent IP address and a Mobile IP type protocol (IP Mobility Support protocol for managing mobility on IP networks) defined by the IETF (Internet Engineering Task Force).

To effect the identification, existing identification and authentication methods and systems rely on the IP address assigned to the user's terminal by the packet network, although in some configurations (private Intranet, Mobile IP, etc.) the terminal uses an IP address different from that assigned by the packet network that the user is accessing.

Thus the technical problem to be solved by the present invention is that of proposing a method and a system for certifying the identity of a terminal user, following a packet network access control procedure, enabling the user to avoid multiple identification and authentication procedures following a packet network access control procedure.

The solution according to the present invention to the technical problem as stated is that said method includes the steps of:

storing a correlation element with an identifier of said user sent by said terminal at the time of a request for connection to the packet network in a database connected to an identity server;

the terminal sending a request including said correlation element to said identity server;

the identity server sending the terminal a cookie that is stored by the terminal;

the identity server storing said cookie in the database in association with said correlation element;

the terminal sending the cookie to a service provider at the time of a request for connection to said service provider;

the service provider sending the cookie to the identity server;

the identity server recognizing the cookie for retrieving said user identifier stored in the database; and

the identity server certifying the identity of the user to the service provider using the certification of the identity of the user effected at the time of executing the procedure for controlling access to the packet network.

In the remainder of this description, the term “cookie” refers to information from the identity server that is stored automatically in the terminal at the time of connecting to the identity server.

Likewise, a system in accordance with the invention for certifying the identity of a user of a terminal following execution of a procedure for controlling access to a packet network is noteworthy in that said system comprises:

an access server adapted to receive a correlation element from said terminal at the time of a request for connection to said packet network;

an identity server adapted to send a cookie to the terminal after receiving a request from said terminal; and

a proxy server adapted to send said correlation element and an identifier of said user from the access server to a database connected to the identity server, the terminal being able to send said cookie at the time of a request for connection to a service provider to retrieve said user identifier sent at the time of executing the procedure for controlling access to the packet network.

Accordingly, the technical result obtained, as implemented in the system and the method according to the invention, aims, in the event of access to a service provider accessible only after further access verification, to re-use the identity certification already effected by the user at the time of a packet network access control procedure.

The system and the method according to the invention therefore simplify access to a service provider by using the certification of the identity of the user already effected at the time of a packet network access control procedure, for example to access the Internet or a private IP network. Information initially received at the time of said packet network access control procedure is re-used to provide a technical solution for certifying the identity of the user at the time of access to said service provider.

This avoids the multiplication of identification and authentication procedures to be effected by the user on each connection request, so that only one identity certification procedure, effected at the time of the packet network access control procedure, is needed. The authentication of the user that has already been effected is then recognized at the time of access to service providers for which a new certification of the user's identity is necessary.

The terminal includes a correlation element in a request sent to an access server at the time of the request to connect to the packet network. The access server delegates the packet network access control procedure to an authentication server using an AAA (authentication, authorization, accounting) type protocol.

This correlation element is used subsequently, at the time of the service provider access control procedure, to retrieve the user identifier (User ID) stored in a database connected to the identity server.

The identity server then man-ages the depositing of a cookie in the terminal when the terminal submits a request after the first access control procedure has been effected.

Finally, the identity server responds to identity certification requests from users wishing to connect to a service provider. The aforementioned cookie is used as a key for consulting the database connected to the identity server to confirm the authentication already effected by the user at the time of connecting to the packet network.

Moreover, and in contrast to existing systems, said method and system in accordance with the invention for certifying the identity of the user provide identification and authentication independently of the IP address assigned to the user's terminal by the packet network.

In accordance with the invention, the correlation element is a random number or a pseudo-random number supplied by the terminal to an authentication server situated in the packet network.

At the time of the request to connect to the packet network, the terminal sends a correlation element to the access server, which forwards it to an authentication server. The correlation element is then stored in a database connected to the identity server, with the user identifier.

In accordance with the invention, an authentication request from the service provider is forwarded to the identity server using a redirection mechanism.

The user accesses a service provided by a service provider that necessitates identity certification. The service provider sends an authentication request. This request is forwarded to the identity server using a redirection mechanism. The service provider then forwards to the identity server the cookie received at the time of the request for connection to the service.

The mechanism of redirection to the identity server avoids a second stage of access control for the connection to the service provider and enables use of the certification of the identity of the user already obtained at the time of the packet network access control procedure.

In accordance with the invention, the identity server uses the cookie as a key for consulting the database to determine the user identifier (User ID).

The identity server has already sent a cookie to the terminal, which forwards the cookie at the time of a request for connection to a service provider.

On receiving the cookie, thanks to the redirection mechanism, the identity server consults the database using the cookie as the consultation key. In return, the identity server obtains the user identifier (User ID).

According to the invention, the terminal is configured to store a correlation element sent at the time of a request for connection to said packet network, to send a request including the correlation element to an identity server, to store a cookie coming from the identity server, and to forward the cookie at the time of a request for connection to a service provider.

The terminal includes an application for storing a correlation element that is sent to an identity server by sending an http request.

This application in the terminal also performs the processing linked to the response from the identity server and depositing a cookie that is stored by the terminal and forwarded at the time of the request for connection to a service provider requiring identity certification.

The following description with reference to the appended drawings, provided by way of non-limiting example, explains in what the invention consists and how it may be reduced to practice.

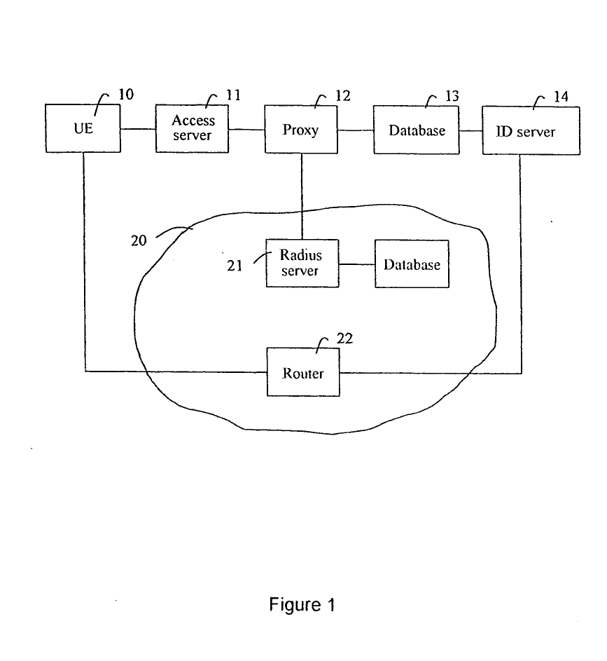

FIG. 1 represents the general architecture of a system according to the invention for certifying the identity of a user at the time of connecting to a packet network.

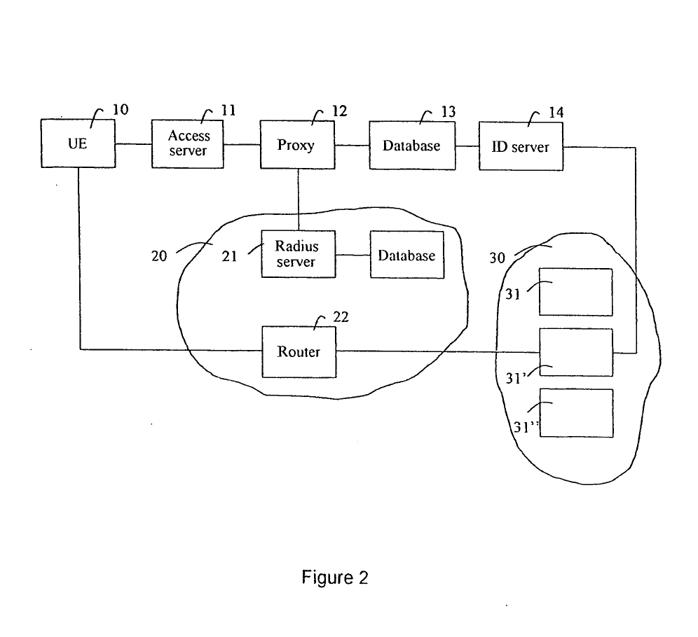

FIG. 2 represents the general architecture of said system for certifying the identity of a user at the time of connecting to a service provider.

A user wishes to access a service provider 30 via a packet network 20 to which the user connects by means of a terminal 10.

The user's terminal 10, labeled UE (user equipment) in FIG. 1, may be of any kind, for example a personal computer or PC, a mobile terminal or any other terminal equipped for issuing a request to connect to said packet network.

The user is a subscriber of a telecommunication operator and is connected to a telecommunication network of said operator that may be either fixed or mobile, depending on the nature of said terminal 10.

The packet network 20 may be a public network for IP (Internet Protocol) packet transmission, in particular the Internet, or a private network for IP packet transmission, such as a company's Intranet, or any other packet network access to which by users is controlled by an AAA (authentication, authorization, accounting) type protocol as defined by the IETF.

The service provider 30 makes available various services 31, 31′, 31″, which may be of any kind, necessitating access control, for example a service for managing leave days on a company's private Intranet or a service for accessing a bank account via the Internet, etc.

The terminal 10 sends a connection request to a server 11 providing access to the packet network 20, which forwards it to an authentication server 21, in particular a Radius (remote authentication dial-in user service) server situated in the packet network 20 to which connection has been requested.

Depending on the kind of access to which the user subscribes via a telecommunications operator, the access server 11 may be a low bit rate NAS (network access server) type equipment or a high bit rate BAS (broadband access server) type equipment, for example. Information is therefore exchanged between the terminal 10 and the access server 11 either at a low bit rate or at a high bit rate, for example using a PPP (point-to-point protocol).

At the time of the request for connection to the packet network, the terminal 10 also sends the access server 11 and the authentication server 21 a user identifier (User ID) and a correlation element.

The correlation element is in particular a random or pseudo-random number supplied by the terminal 10 to an authentication server 21 situated in the packet network.

For example, the correlation element may be supplied to the terminal 10 by the access server 11 at the time of the request for connection to the packet network 20, on opening the PPP (LCP layer) dialogue, or the terminal 10 may base the correlation element on data supplied by the access server 11.

The terminal 10 includes an application for managing a PPP (point-to-point protocol) stack. The terminal 10 is therefore configured to store data sent by the access server 11 and received at the time of the request for connection to the packet network 20. The terminal 10 also stores the correlation element.

The access server 11 forwards the connection request to a proxy server 12, for example of the Radius type, through which information exchanged between each user terminal and the authentication server 21 circulates. The proxy server 12 then forwards the connection request to the authentication server 21, in particular a Radius server.

Following a connection request, access to the packet network 20 is controlled by an identification and authentication procedure using an identifier (or “Login”) and a password, for example. If access is validated (if the Login and password are correct), the authentication server 21 sends an authorization to connect the terminal 10 to the packet network 20. The connection request is stored in a database connected to the authentication server 21.

The Radius protocol, which is dedicated to authentication, is specified by the IETF and standardized by the ETSI (European Telecommunications Standards Institute).

Once connection has been authorized, the proxy server 12 forwards the user identifier (or User ID) and the correlation element from the access server 11 to a database 13 connected to an identity server 14. The database 13 stores the correlation element with the user identifier sent by the terminal 10 at the time of the request to connect to the packet network.

The proxy server 12 also acknowledges the request to connect the terminal 10 to the packet network 20.

The terminal 10 then sends a request including the correlation element to the identity server 14 via the access server 11 and a router 22 situated in the packet network 20.

In particular, the request may use an http (hypertext transfer protocol) type transfer protocol usually employed for sending information, in particular for the purposes of including said correlation element.

After reception of the request, the identity server 14 sends the terminal 10 a cookie adapted to be stored automatically by the terminal 10.

The terminal 10 is configured to send the identity server 14 a request, for example a request using an http stream transfer protocol, and to perform the processing linked to the response of the identity server 14, i.e. receiving and storing a cookie.

Moreover, the identity server 14 contacts the database 13 in which the user identifier (or User ID) and the associated correlation element are already stored. Thanks to the received and known correlation element, the identity server 14 updates the database 13 by adding the cookie sent to the terminal 10, in association with the correlation element.

The cookie is stored in the database 13 in association with the correlation element. The database 13 may be a physical part of the identity server 14 or located elsewhere.

Once the connection to the packet network 20 has been set up, the user issues a request for connection to a service provider 30 that provides a service 31, 31′, 31Δ requiring access control, for example access to a personalized or confidential service, such as a banking service or a company's private service, as represented in FIG. 2.

The terminal 10 also sends the service provider 30 a cookie at the time of the request for connection to the service provider 30. The cookie is used to retrieve the user identifier stored in the database 13 connected to the identity server 14 at the time of the access control procedure in respect of the packet network 20.

This sending is effected via the access server 11 and the router 22. As the service 31, 31″, 31Δ is accessible only after an access control procedure, the service provider 30 sends an authentication request.

The request is sent to the identity server 14 using a redirection mechanism. The service provider 30 sends the received cookie to the identity server 14.

The redirection mechanism may be similar to those based on recommendations issued by the Liberty Alliance consortium, for example, the objective of which is the expansion of Internet transactions.

The mechanism for redirection to the identity server 14 avoids a second access control procedure in respect of the connection to the service 31, 31″, 31″ and enables the use of the certification of the user identity already effected at the time of the access control procedure for the connection to the packet network 20.

The identity server 14 recognizes the cookie for retrieving the user identity stored in the database 13. On receiving the known cookie, the identity server 14 consults the database 13 using the cookie as the consultation key. In return, the identity server 14 obtains the user identifier (or User ID).

The identity server 14 uses the cookie as a key for consulting the database 13 to determine the user identifier.

The identity server 14 sends the user identifier to the service provider 30, avoiding further authentication of the user following the authentication already effected at the time of the access control procedure for the purposes of access to the packet network 20.

The identity of the user is certified by the user identifier. The service provider 30 therefore recognizes the user and obtains a certification of that user's identity effected by the identity server 14. The identity server 14 certifies the identity of the user to the service provider 30 using the certification of the identity of the user effected at the time of the access control procedure for the purposes of access to the packet network 20.

Moreover, the identity server 14 can also specify the type of authentication used by the user, so as (if necessary) to indicate the reliability of the certification sent by the identity server 14 to the service provider 30. The service provider 30 then sends the connection authorization to the terminal 10.

By way of simplification, it is technically feasible to use the user identifier (or User ID) as the correlation element, as a function of the level of security required or wanted. To prevent fraud and to increase security, the use of a random or pseudo-random correlation element, as described above, is recommended.

Thanks to the redirection mechanism, the service provider 30 receives the certification of the identity of the user effected by the identity server 14. Generally speaking, this certification of the user's identity is based on the user identifier (or User ID). It may also be based on an equivalent identity contained in said database 13. For this to be possible, the user must have previously sent the information corresponding to that equivalent identity. The user also indicates a preference as to whether the identity server 14 should use either the user identifier (or User ID) or the equivalent identity.

1. A method of certifying the identity of a user of a terminal (10) following execution of a procedure for controlling access to a packet network (20), wherein said method includes the steps of:
storing a correlation element with an identifier of said user sent by said terminal (10) at the time of a request for connection to the packet network (20) in a database (13) connected to an identity server (14);
the terminal (10) sending a request including said correlation element to said identity server (14);
the identity server (14) sending the terminal (10) a cookie that is stored by the terminal (10);
the identity server (14) storing said cookie in the database (13) in association with said correlation element;
the terminal (10) sending the cookie to a service provider (30) at the time of a request for connection to said service provider (30);
the service provider (30) sending the cookie to the identity server (14);
the identity server (14) recognizing the cookie for retrieving said user identifier stored in the database (13); and
the identity server (14) certifying the identity of the user to the service provider (30) using the certification of the identity of the user effected at the time of executing the procedure for controlling access to the packet network (20).

2. The method according to claim 1, wherein said correlation element is a random number or a pseudo-random number supplied by the terminal (10) to an identification server (21) situated in the packet network (20).

3. The method according to either claim 1, wherein said request sent from the terminal (10) to the identity server (14) uses an http stream transfer protocol so that it can include said correlation element.

4. The method according to claim 1, wherein the service provider (30) sends an authentication request to the identity server (14) using a redirection mechanism.

5. A The method according to claim 1, wherein the identity server (14) uses said cookie as a key to consult said database (13) to determine the user identifier.

6. A system for certifying the identity of a user of a terminal (10) following execution of a procedure for controlling access to a packet network (20), wherein said system comprises:
an access server (11) adapted to receive a correlation element from said terminal (10) at the time of a request for connection to said packet network (20);
an identity server (14) adapted to send a cookie to the terminal (10) after receiving a request from said terminal (10); and
a proxy server (12) adapted to send said correlation element and an identifier of said user from the access server (11) to a database (13) connected to the identity server (14),
wherein the terminal (10) is able to send said cookie at the time of a request for connection to a service provider (30) to retrieve said user identifier sent at the time of executing the procedure for controlling access to the packet network (20).

7. The system according to claim 6, wherein said terminal (10) is connected to a fixed or mobile telecommunication network.

8. The system according to claim 6, said packet network (20) is an IP transmission network.

9. An access server (11) adapted to be used in a system according to claim 6, wherein the access server is configured to receive and forward a request for connection to said packet network (20) from the terminal (10), to receive a correlation element sent to the terminal (10) at the time of said connection request, to receive a request from the terminal (10) and to forward it to an identity server (14), and to receive a cookie from the terminal (10) and forward it to a service provider (30).

10. The access server (11) according to claim 9, wherein information is exchanged between the terminal (10) and the access server (11) at a low bit rate or a high bit rate.

11. A proxy server (12) adapted to be used in a system according to claim 6, wherein the proxy server configured to receive a request for connection to said packet network (20) from said access server (11) and to forward it to an authentication server (21), to receive an identifier of said user and a correlation element from the terminal (10) and to forward them to a database (13) connected to an identity server (14), and to acknowledge said request for connection of the terminal (10) to the packet network (20).

12. The proxy server (12) according to claim 11, wherein the proxy server is of the Radius type, through which information exchanged between each user terminal (10) and said authentication server (21) circulates.

13. An identity server (14) adapted to be used in a system according to claim 6 wherein the identity server is configured to receive and forward a request including a correlation element from said terminal (10), to send a cookie to the terminal (10) and to a database (13) connected to said identity server (14), to receive an authentication request from a service provider (30), and to send the service provider (30) an identifier of said user from said database (13).

14. A terminal (10) adapted to be used in a system according to claim 6, wherein said terminal is configured to store a correlation element sent at the time of a request for connection to said packet network (20), to send a request including said correlation element to an identity server (14), to store a cookie from said identity server (14) and to forward said cookie at the time of a request for connection to a service provider (30).
